(19) United States
(12) Patent Application Publication
(10) Pub. No.: US 2012/0323626 A1
(43) Pub. Date: Dec. 20, 2012

(54) APPARATUS FOR SCHEDULING STAFF BASED ON NORMALIZED PERFORMANCE

(75) Inventors: Philip H. Beauregard, New Bedford, MA (US); Matthew Grace, New Bedford, MA (US); Danying Shao, New Bedford, MA (US)

(73) Assignee: Objective Logistics

(21) Appl. No.: 13/528,366

(22) Filed: Jun. 20, 2012

Related U.S. Application Data
(60) Provisional application No. 61/498,939, filed on Jun. 20, 2011.

(51) Int. Cl. G06Q 10/06

(52) U.S. Cl. 705/7.18; 705/7.13

(57) ABSTRACT

A method is disclosed including: using at least one point of sale terminal to record sales information related to each of a plurality of staff members of an enterprise; using a rostering module coupled to the point of sale terminal to generate information indicative of staff performance by generating a performance score for each staff member that is based on sales information for the staff member and on aggregate sales information for the enterprise; and using the rostering module to generate a roster for scheduling staff members in scheduling slots based on each staff member's performance score.

### CROSS REFERENCE TO RELATED APPLICATIONS

This application claims the benefit of U.S. Provisional Pat. No. 61/498,939, entitled APPARATUS FOR SCHEDULING STAFF BASED ON NORMALIZED PERFORMANCE, filed Jun. 20, 2011, the entire contents of which are incorporated herein by reference.

### FIELD

This invention optimizes service staff performance and provides a scheduling apparatus with incentivizing service staff to please customers and increase sales.

### BACKGROUND

Inherent in the restaurant industry is complacency of service staff, an innate quality of the restaurant workforce. Service staff-typically a waiter, waitress or bartender, should focus on maximizing customer satisfaction and good will, resulting in higher receipts. Servers can become comfortable with a certain level of performance regarding their sales and the amount they receive in tips. However, this comfort level is counterproductive to the restaurant's desire to grow. Those with longer tenure expect to have their pick of shifts. Most seek to work the best shifts, e.g. Friday nights, when the sales and tipping are highest.

Moreover, cliques come into play, as well as internal politics between service staff and management. Also, there may be favoritism in the manager's treatment of the workforce with respect to scheduling.

One of the largest concerns for restaurant management is scheduling. Scheduling bears directly on an employee's earning capability. Note, there is a large difference in tips earned between a Monday lunch shift and a Friday night dinner shift. In a small enterprise, waiters might typically earn $20 during a Tuesday lunch shift, but as much as $200 on a Friday night shift. Thus, service staff typically strives to secure the most desirable shifts.

However, there is no mechanism presently in place that gives restaurant management the ability to schedule service staff with a comprehensive logistics program based on incentive and performance. A merit-based system that encourages better service and better profits for the owners of the establishments is required. Moreover, there is a requirement for staffing apparatus that allows the servers to control their own fate and earning potential.

Scheduling is a crucial concern for restaurant owners because service staff function as the front line of the restaurant. Service staff members are the first point of contact for customers and guide the guest through his or her experience, the food itself only going so far. The restaurant industry is a customer service industry. Studies show that patrons who leave unsatisfied may tell twenty friends that they had a bad experience, whereas if they leave satisfied they will tell only two. Thus, service staff determines the word-of-mouth reputation of the restaurant.

In terms of restaurant profits, the duty of the service staff should be to up-sell. For instance, the server may say seek to ascertain if the customer has a preferred vodka, “do you have a preference in vodka?” They can up-sell because well vodka provides less margin for the restaurant than selling a premium brand. On the other hand, premium vodkas, which are at a higher price point, provide a larger profit margin and usually a better product for the patron (thus also adding to their experience).

The same up-selling occurs with various menu items. For instance, the server may push a higher priced/margin appetizer by telling the patron that the restaurant has a really good crab cake dish. A server may simply encourage a guest to purchase a dessert when they weren't planning to in the first place. Each instance increases a restaurant's bottom line. Service staff members are thus encouraged to suggest what the customer should buy, and that they should buy more.

For example, consider a small enterprise with ten servers, five scheduled for the lunch shift and five for the dinner shift. James Sullivan, a well-known industry analyst, asserts that up-selling works 58-72% of the time. If each of these servers accommodate five tables during a shift, and if they are able to up-sell $4 for a menu item 58% of the time, by the end of the year the increase in revenue to the restaurant will be upwards of $70,000, assuming that the restaurant is open 300 days a year. So if the ultra conservative worst-case scenario is that the service staff only manages to add $4 an item 58% of the time, then the up-selling campaign is a land office success.

As to prior methods of scheduling, scheduling is done by the manager in a manual pencil and paper operation where the manager sits for several hours, doing a months worth of scheduling based upon what the service staff have written down as to their availability. Service staff advises managers of their availability during a specific time period and the manager then creates a schedule for the month. The manager has an idea of whom he wishes to place on the Friday night shifts. However, the largest problem in the industry is when favoritism, nepotism, or even tenure comes into play. For instance, managers often automatically give the server who has been there 25 years the Friday night shift. Others might give the Friday night shift to their best friends. Managers usually range between 25 and 35 years in age and oftentimes their best friend works at the restaurant. If such is the case the manager will frequently schedule them for Friday nights as much as possible.

However, this is deleterious to the restaurant business because the management is not necessarily putting the best seller at the appropriate shift. The best seller is the person who is pleasing the customer the most and selling the most product, and should be scheduled on nights for which there is the maximum potential for revenue and customer face time.

Scheduling software such as ScheduleFly and HotSchedules utilize semi-automated computer systems to schedule based solely on the availability of the staff and the labor forecast. The labor forecast is what the restaurant thinks the amount of servers and hours should be for a given day according to their estimates of how much food and beverage they are likely to sell. However, none of the above scheduling software considers service staff performance or provide fully-automated schedule generation.

### SUMMARY

In contradistinction to prior manual and computerized systems based solely on availability and labor forecast, the subject apparatus involves a performance-based scheduling system based on scores for the staff in which the top performing staff members are awarded the best shifts. This system puts the restaurant's best face forward at times where there is the most potential for sales. Most importantly, it encourages the highest levels of customer satisfaction coupled with the highest level of sales.

The subject performance-based system creates a competitive environment based on microeconomic principles that theorize that when competition arises, one can get the most efficiency out of a resource in this case the service staff. When servers know that their scheduling, their pocket money, and in fact their livelihoods are based on their performance, they will compete to get the best shifts and thus generate the larger amounts of money, not only for themselves, but also for the enterprise. They will balance this with maintaining the highest standards of customer satisfaction, resulting in exponential revenue generation for the enterprise moving forward.

If servers come in feeling ill or having a really bad day, and if they don't up-sell at every opportunity, their scores will be lowered, meaning that they will be given less desirable shifts. This in turn costs the server money and aligns the interests of the server with those of the restaurant.

Note that when a server has a bad day, this costs the restaurant both in reduced sales and negative customer experience.

In the subject invention a scheduling module is coupled to a point of sale device (POS) from which sales and tips data are available. The scheduling module implements a linear grading algorithm in which the formula derives a raw score by measuring individual components of employee performance and factors them into a summarized score.

The first component is sales ability and is based on adjusted gross sales per diner. It is noted that there are going to be differences in ability to sell based on the menu, the shift, and the price of the items during that shift. For instance a piece of steak at lunch is going to cost perhaps around 20% less than the same piece of steak at dinner. Thus, sales off the lunch menu are going to be less than sales off the dinner menu.

Therefore, the sales ability portion of the subject algorithm includes a menu price index, MPI, in which all the prices on each menu are totaled, with the dinner menu sales in practice being discounted to be equivalent to those of lunch menu sales. This adjusted gross sales factor is then divided per diner to achieve parity for a server's sales during any given shift, regardless of menu prices or customer traffic.

Thus, if one has a slow shift at lunch where the server only accommodates two tables, whereas a second server comes in Friday night and serves twenty tables, the number of tables is taken out of the equation by using a per diner metric. There is equivalence in the scoring system in the menus and the ability to sell so as to put all servers on par. It is therefore one aspect of the subject invention that the ability to sell includes adjusted gross sales per diner, the first component of the formula used in the subject system.

As will be appreciated, by utilizing adjusted gross sales per diner, one derives a revenue function in the scoring system to enable the restaurant to see who is aligning their sales incentives with those of the restaurant.

The second component in the score is “customer satisfaction.” Restaurants don't want to push items on customers based solely on the establishment's need to increase sales. To do so would be reducing the restaurant business to an assembly line, rather than a customer service industry giving patrons a good experience so that they will return and tell their friends. The industry is a well-known word of mouth industry, so the customer satisfaction score component is highly significant.

Customer satisfaction in the subject invention is based on tips or gratuities. The purest way to judge how satisfied a customer is on average based on how large the tip is. One metric used in the subject invention is the percentage that the tip represents in terms of the bill.

In the subject invention the tips are tallied and scrubbed off or downloaded from a point of sales (POS) terminal, which makes available a tips database that cannot be manipulated by any of the managers. Thus, the second component in the score is arrived by scrubbing the credit card receipts from the point of sale system, by which the establishment can find out how the service staff has fared in a given shift, based on tip percentages. It is also within the scope of this invention to use gross tips, as opposed to tip percentages.

However, in the preferred embodiment if Mary has a 20% tip percentage, she in general is doing a better job on a given shift than Billy who only has an 18% tip percentage. Thus, the subject system allows the establishment to judge the server according to what the customer feels about the experience, and rates customer satisfaction in terms of the tip percent of the overall bill.

The subject system can optionally integrate a cash tipping system in which the server at cash out indicates to the establishment the total amount of tips they received. In so doing, the subject system takes away the moral hazard stemming from underreported tips. The reason is that the server's score is going to be lower if she underreports her tips and therefore will be assigned less desirable shifts. Thus, the server's ability to make money is going to be lower in the future if she underreports her tips. Of course if she over reports her tips in order to get a better score then she pays more in taxes.

The third component for the subject algorithm is a management defined component which in one embodiment results in merit and demerit points added to or subtracted from the score. The management defined component can involve nuances with various weights given to various different factors, adjusted in accordance with restaurant goals.

There are several server activities that would result in demerits. One could be physical appearance. For instance if a server does not shave for days, then he may be given a demerit. If a server is standing around when he or she is supposed to be doing side work, a demerit can be given.

However, in one embodiment when giving a demerit the subject invention requires the management to give the reason for the demerit. To avoid favoritism; management is required to account for point manipulation.

There are also merit points that can be added to the score for the server. Merit points, for instance, can be earned based on positive customer comment cards. Also, a merit point may be afforded to staffers making an exemplary effort in bringing hot food to the tables or helping out their fellow service staff, or simply by increasing operational efficiency by clearing off tables that are not assigned to them.

Thus merits and demerit points can be centered around positive customer comments, neatness, relationship to the cooking staff, tardiness, cell phone usage and texting, not doing side work, not washing hands, not picking up someone's shift, and wasting food. Wasting food comes into play when the server does not get the order correct. For instance, if the server orders the wrong type of steak then the item is a wasted item.

In the subject system the emplaced POS equipment in the restaurant is utilized to scrub data. The POS system holds all of the information about the restaurant so management can be apprised of the sales, the quantities and items sold and at what times, by whom and to how many tables, even keeping track of the number of people at a table and gratuities received, along with other data sets.

In one embodiment, the subject invention provides access to the service staff so that scoring is accessible by both staff and management.

It is central to the subject invention that the score generated by the subject apparatus determines the roster or schedule, such that the subject invention rosters employees according to their scores from top to bottom. The system also has an input related to the availability of each of the service staff; and part of the subject invention is such that if a top scoring staff member cannot work on a Friday night the system will automatically provide him or her with the next best shift.

Thus, there is a hierarchy of desirable/profitable shifts, forming one of the inputs to the rostering module in which the server with the highest score is placed in a shift that is determined by the hierarchy to be the best shift, i.e. most potential for revenue generation and customer face time.

In summary, the subject apparatus provides the establishment with the ability to schedule staff based on the best potential for customer satisfaction and ability to sell, which is in turn based on objective data.

This enables the restaurant to schedule the best of the service staff at the most profitable times of the week and eliminates deadweight loss by providing a schedule that is the best use of service staff. As a result, the subject apparatus creates an efficiency where there was none.

It is in the interest of the establishment to want the best server who makes the customers the happiest and sells the most, according to the historical data, this server is placed front and center on the night with the most customers.

In one embodiment, the scoring system and its inner layers are accessible by the service staff via a web portal. This empowers the server to fix their performance and tweak it to see what exactly they have done right, what they have done wrong and what they need to do to improve and move forward in a positive manner for both themselves and the restaurant.

Note that the incentives for the server and the restaurant are aligned. Servers want to sell more because they will get a higher amount of tips, and the restaurant wants them to sell more because the restaurant will make a higher profit. The restaurant wants the servers to treat the customer better because the customer will not only come back, but also tell people about it, which means increased future traffic. The server wants to treat customers better because the customers tip better when they have a more pleasant experience. Thus, all incentives are aligned.

An apparatus is provided to schedule or roster service staff based on performance, with performance measured by a score that includes adjusted gross sales per diner, the tips or tip percentages that the service staff receive, and merit and demerit points under the control of the restaurant management. The subject system takes out favoritism and combats complacency by quantifying server performance and providing server competition in a manner intended to increase restaurant revenues and provide a better, more pleasant experience to restaurant guests.

In one aspect, a method is disclosed including: using at least one point of sale terminal to record sales information related to each of a plurality of staff members of an enterprise; using a rostering module coupled to the point of sale terminal to generate information indicative of staff performance by generating a performance score for each staff member that is based on sales information for the staff member and on aggregate sales information for the enterprise; and using the rostering module to generate a roster for scheduling staff members in scheduling slots based on each staff member's performance score.

Some embodiments include, for each of the plurality of staff members, generating a corresponding performance score by: grouping the staff member's sales information into a plurality of categories; obtaining aggregate sales information for the enterprise corresponding to each of the categories; and normalizing the staff member's sales information for each category based on the corresponding aggregate sales information.

In some embodiments, the categories include temporal categories. In some embodiments, the temporal categories are based on the day of week and time of day. In some embodiments, the categories include spatial categories.

In some embodiments, the step of generating a performance score for each staff member that is based on sales information for the staff member and on aggregate sales information for the enterprise includes: calculating a performance score based on staff member sales information and aggregate sales information generated over a period of time, where the performance score more heavily weights staff member sales information and aggregate sales information that is more recent in the period of time.

In some embodiments, at least one of the staff member sales information and aggregate sales information is weighted by a factor that decreases exponentially as a function of how distant in the past the information was generated.

In some embodiments, the enterprise includes a restaurant; each staff member's sales information includes a plurality of check records, each check record including: party size information indicative of the number of persons in a party served by the staff member; and total sales information indicative of the total sales for the party. Some embodiments include, for each staff member: generating per person average sales information indicative of the sales per person served by the staff member based on the plurality of check records.

In some embodiments, each check record includes: a party size entered by the staff member; and seating information indicative of the number of seats at a dining table served. In some embodiments, generating per person average sales information indicative of the sales per person served by the staff member based on the plurality of check records includes: dividing the total sales for a party by the larger of the party size entered by the staff member and the number of seats.

Some embodiments include providing one or more interfaces configured to allow a first staff member to confirm or dispute the party size or seating information in a check record of a second staff member.

Some embodiments include: identifying check records as outliers based on per person average sales information; and removing the outliers from consideration in generating the staff member performance scores.

In some embodiments, the aggregate sales information for the enterprise includes information indicative of an average of the per person average sales for the plurality of staff members.

Some embodiments include: categorizing the aggregate sales information based on the time of day and day of week of the sales.

Some embodiments include categorizing the aggregate sales information based on the spatial locations of the sales within the restaurant.

In another aspect, an apparatus is disclosed including: at least one point of sale terminal configured to record sales information related to each of a plurality of staff members of an enterprise; and a rostering module coupled to the point of sale terminal and configured to generate information indicative of staff performance by generating a performance score for each staff member that is based on sales information for the staff member and on aggregate sales information for the enterprise. In some embodiments, the rostering module is configured to generate a roster for scheduling staff members in scheduling slots based on each staff member's performance score.

In some embodiments, the rostering module is configured to, for each of the plurality of staff members, generating the performance score by: grouping the staff member's sales information into a plurality of categories; obtaining aggregate sales information for the enterprise corresponding to each of the categories; and normalizing the staff member's sales information for each category based on the corresponding aggregate sales information.

In some embodiments, the categories include temporal categories. In some embodiments, the temporal categories are based on the day of week and time of day. In some embodiments, the categories include spatial categories.

In some embodiments, the rostering module is configured to generate a performance score for each staff member that is based on sales information for the staff member and on aggregate sales information for the enterprise by: calculating a performance score based on staff member sales information and aggregate sales information generate over a period of time, where the performance score more heavily weights staff member sales information and aggregate sales information that is more recent in the period of time.

In some embodiments, at least one of the staff member sales information and aggregate sales information is weighted by a factor that decreases exponentially as a function of how distant in the past the information was generated.

In some embodiments, the enterprise includes a restaurant; and each staff member's sales information includes a plurality of check records, each check record including: party size information indicative of the number of persons in a party served by the staff member; and total sales information indicative of the total sales for the party.

In some embodiments, the rostering module is further configured to, for each staff member: generate per person average sales information indicative of the sales per person served by the staff member based on the plurality of check records.

In some embodiments, each check record includes a party size entered by the staff member; and seating information indicative of the number of seats at a dining table served. In some embodiments, the rostering module is configured to generate per person average sales information indicative of the sales per person served by the staff member based on the plurality of check records by: dividing the total sales for a party by the larger of the party size entered by the staff member and the number of seats.

Some embodiments include one or more interfaces configured to allow a first staff member to confirm or dispute the party size or seating information in a check record of a second staff member.

In some embodiments, the rostering module is configured to: identify check records as outliers based on per person average sales information; and remove the outliers from consideration in generating the staff member performance scores.

In some embodiments, the aggregate sales information for the enterprise includes information indicative of an average of the per person average sales for the plurality of staff members.

In some embodiments, the rostering module is configured to: categorize the aggregate sales information based on the time of day and day of week of the sales.

In some embodiments, the rostering module is configured to: categorize the aggregate sales information based on the spatial locations of the sales within the restaurant.

In another aspect, a system is disclosed including: the apparatus of any of the types described above and a database coupled to the apparatus and configured to store the sales information related to each of a plurality of staff members of an enterprise.

Some embodiments include an output device for outputting information generated by the rostering module.

Various embodiments may include any of the features, elements, steps, etc. described above, either alone or in any suitable combination.

### BRIEF DESCRIPTION OF THE DRAWINGS

These and other features of the subject invention will be understood in connection with the Detailed Description in conjunction with the Drawings, of which:

FIG. 1 is a diagrammatic illustration of the use of the subject apparatus in a restaurant scene in which a point of sale terminal is scrubbed, data is downloaded to a roster generating module that incorporates a server scoring algorithm, and an optimized roster or schedule is generated;

FIG. 2 is a diagrammatic illustration of the algorithm utilized in which sales are combined with customer satisfaction and a management defined set of parameters to provide a raw score;

FIG. 3 is a diagrammatic illustration of the sales component of the subject algorithm, including derivation of score statistics and the parity created between breakfast, lunch and dinner menus, normalizing different shifts for the purpose of objectively determining sales ability;

FIG. 4 is a diagrammatic illustration of the ability to obtain customer satisfaction in terms of the tip percentage a server receives;

FIG. 5 is a diagrammatic illustration of the management defined input, in which merit and demerit points are added or subtracted from the score to adjust for management-defined criteria;

FIG. 6 is a diagrammatic illustration of the process flow utilized by the roster module to provide optimized scheduling, including development of adjusted gross sales per diner and tips scrubbed from point of sale data, which are combined with management defined merit and demerit points to obtain a raw score that also takes into account the availability of staff; and,

FIG. 7 is a diagrammatic illustration of the hardware components of the subject invention including a point of sale terminal, a rostering module, a display for the optimized roster/schedule and a roster printer.

FIG. 8A is a diagrammatic illustration of a dining check for a table with a party of two, where each ordered menu item is assigned to a seat number.

FIG. 8B is a diagrammatic illustration of a dining check featuring a suspicious assignment of menu items to seat numbers.

FIG. 9 is a diagrammatic illustration of the algorithm utilized for normalizing per person average sales to account for temporal average sales variation.

FIG. 10 is a diagrammatic illustration of the process flow for ranking employees based on performance.

FIG. 11A shows an exemplary computer code listing for function used in calculating a storewide average PPA matrix.

FIG. 11B shows an exemplary computer code listing for implementing process step 1003 shown in FIG. 10.

FIG. 11C shows an exemplary computer code listing for implementing process step 1003 shown in FIG. 10.

### DETAILED DESCRIPTION

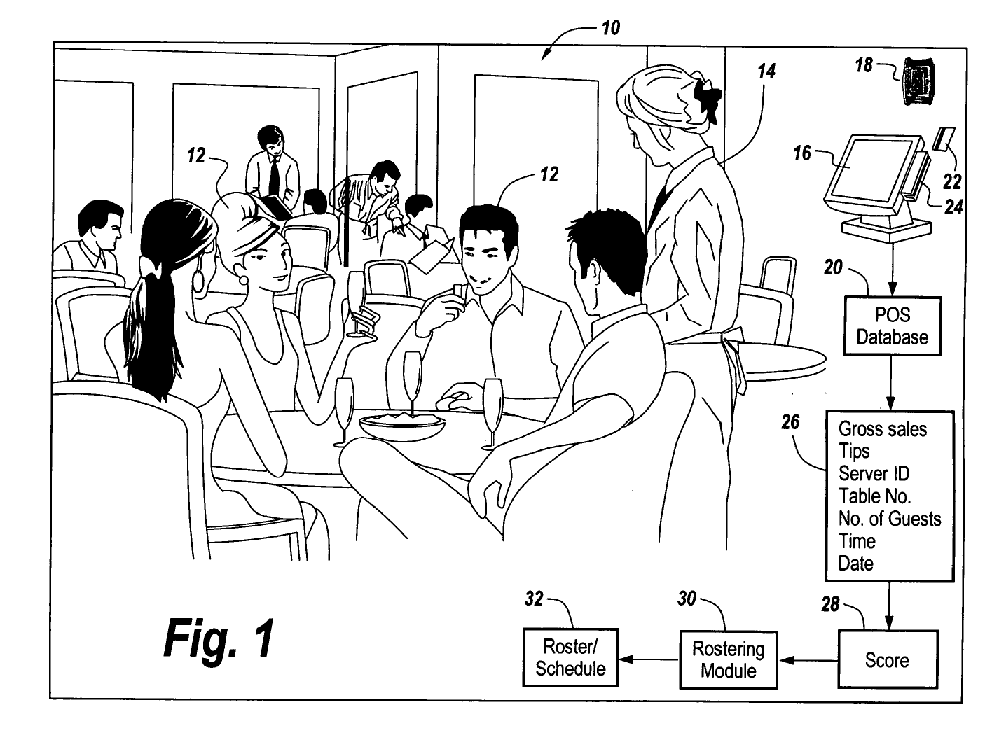

Referring now to FIG. 1, a restaurant scene 10 is depicted in which customers 12 are being waited on by a server 14. The server takes the customers' orders and inputs them directly into a point of sale (POS) terminal 16 or wirelessly via handheld point of sale terminal device 18 in order to populate a point of sale database 20.

After the meal, a bill or check is presented by the server and is paid for in one embodiment by a credit card 22, which is slid through a credit card reader 24.

The result of the ordering and the credit card transaction is a scrubbing or downloading of point of sale data 20 to output gross sales, tips, server identification, table number, number of guests at the table, time and date as illustrated at 26 which is the data used to provide a score 28 to a rostering module 30 that utilizes this score and produces an optimized roster or schedule 32.

The objective is to provide a platform to automate the particular restaurant business function while optimizing performance. The subject invention provides an automated apparatus that maximizes revenue and customer satisfaction for the restaurant. It also allows management and staff to access business intelligence for purposes of establishing best practices. The subject invention encourages compliance, which is quick and easy to implement with minimal manual input and maintenance, resulting in an instantaneous and dramatic return on investment.

As mentioned above, one of the largest problems in the restaurant industry is staff underperformance and apathy. Complacency, as illustrated by the notion that senior staff members have their choice of shifts, is not best case for restaurant scheduling. Moreover, managers are often unconsciously adhering to unspoken rules of staffing and can often fall victim to favoritism in the workplace. The subject apparatus, through the scoring described herein, provides competition that stimulates innovation and increases efficiency. It encourages staff to put their best foot forward at all times, to actively sell as much product as possible and to keep the customer's ultimate satisfaction in mind. The system affects server income and competition increases their performance, rewarding to those who perform, and giving them the shifts where opportunity to make money is the greatest.

The establishments that can benefit from the utilization of the subject system are those who wish to increase same store sales and revenue while streamlining operational efficiency and dramatically improving customer satisfaction.

The system also relieves managers who spend extra time scheduling and aids managers who would like to avoid politics surrounding scheduling. The system also permits managers and service staff to analyze objective data for the sake of improving performance metrics. As a result, the system benefits servers who wish to be compensated for good performance.

In one embodiment there are three distinct components accessible by a web-based portal. The first and most important is the optimization engine that feeds a dynamic scheduler and in turn provides business intelligence to a business intelligence portal and data analyzer.

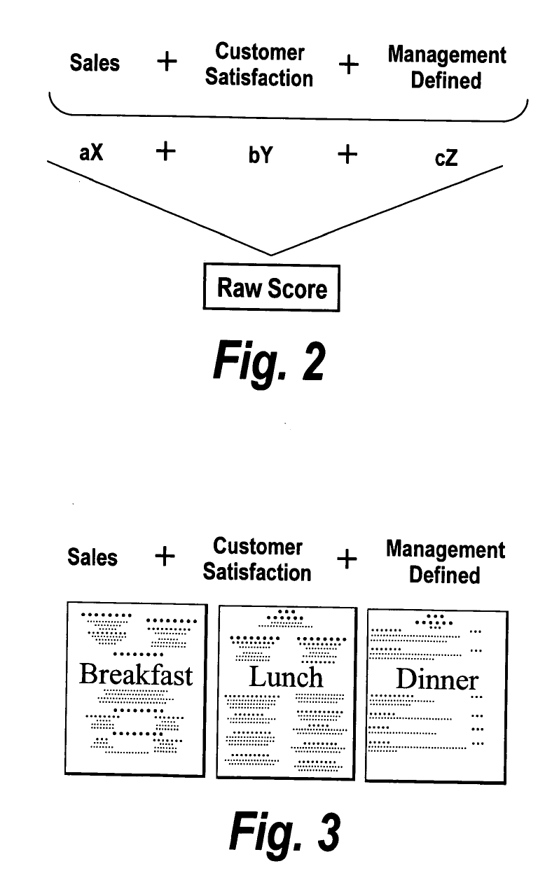

As seen in FIG. 2, the system for downloading point of sale terminal data providing the raw score for the generation of a schedule or roster is comprised of three components. The first is sales, the second is customer satisfaction and the third is a management-defined variable. The subject invention includes a rostering module that generates a raw score and schedules the staff in a hierarchical pattern, with those scoring the highest being placed during the busiest shifts.

The raw score in one embodiment is computed over a discrete period of time enabling a “clean slate” every period for an employee to outperform other employees and thus attain better shifts.

Note that employees with the highest scores are placed into a schedule during shifts with the greatest sales or customer face time potential, historically derived or ranked by management, taking into account constraints or availabilities entered previously. Thus, the system may be customized for each business.

As to sales, as depicted in FIG. 3 the sales can occur at a breakfast, lunch or dinner shift normalized via a menu price index computed off the total value of the items on each shift's menu. Note that certain items can be removed from scoring such as kids menu items, voids or split dinners.

In the subject system server sales are normalized by the menu price index in order to make all sales equivalent. Thus, if the lunch menu is worth 77% of the dinner menu, a server working the dinner shift will have sales adjusted 33% lower to normalize the scoring output.

A server's total menu price index adjusted sales for a given shift are then divided by the number of customers serviced, resulting in an adjusted gross sales per diner metric. This is the first component of the server's raw score.

Customer satisfaction is the second component of the score, best measured by the tip percentage a server receives. It is a feature of the subject invention that servers can be distinguished in terms of tip percentage.

The subject system downloads the data off the restaurant infrastructure system point of sale terminal at the end of each shift and computes the tip percentage a server made during the shift.

During the defined time period the percentage will be computed for all of the server's shifts and will be entered into their customer satisfaction score component.

It is an optional feature of the subject invention that cash tip percentage can be ascertained and utilized by the rostering module, forcing the server to either report tips accurately for added tax compliance, or suffer in raw score. Adding a cash-tip percentage to the subject system erases the moral dilemma associated with tip under-reporting.

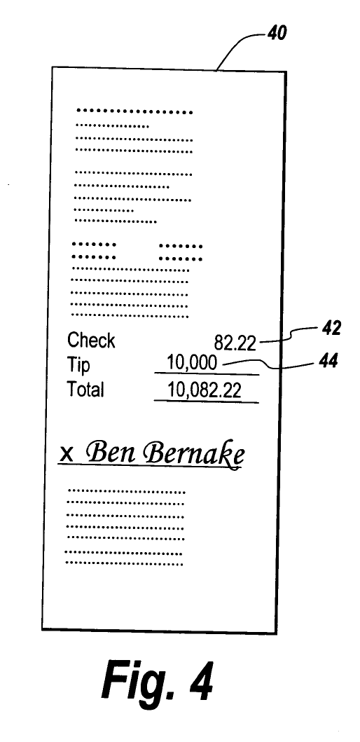

As can be seen in FIG. 4, a typical check 40 includes the sales amount 42 and the tip 44 associated with the sale, with the sales slip totals being available from point of sale terminal output data.

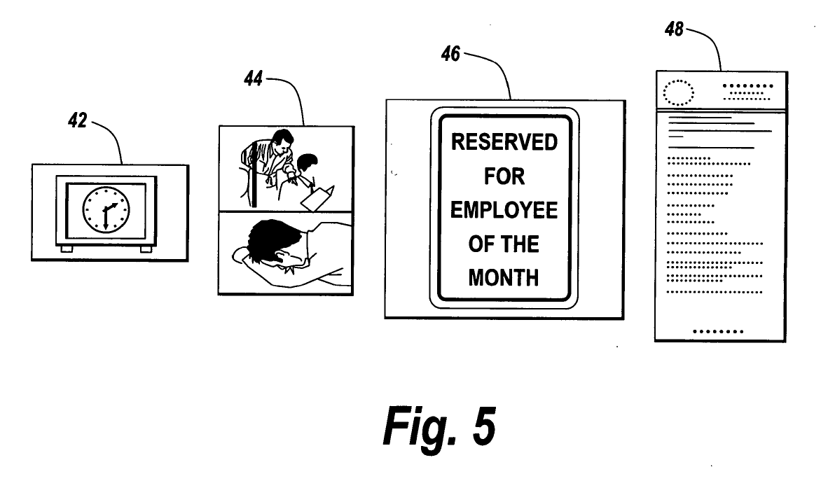

As shown in FIG. 5, management defined merit or demerit points are factored into the score with sales and customer satisfaction. As indicated above, demerits can relate to a timeliness issue as illustrated at 42, sleeping on the job as illustrated at 44, or may include merit points that relate to employee outperformance at 46 or positive customer experiences at 48.

The merit and demerit categories in one embodiment are available in a pick-list format, with management able to add specific categories to increase user friendliness. Thus, category creation and value manipulation is available with a click of the mouse. As a result, the component is controlled by management directive.

Note, as to numerical values, the demerit/merit system can be given less weight than gross sales per diner and tips. This component can therefore serve more as a tweak to the “raw score.”

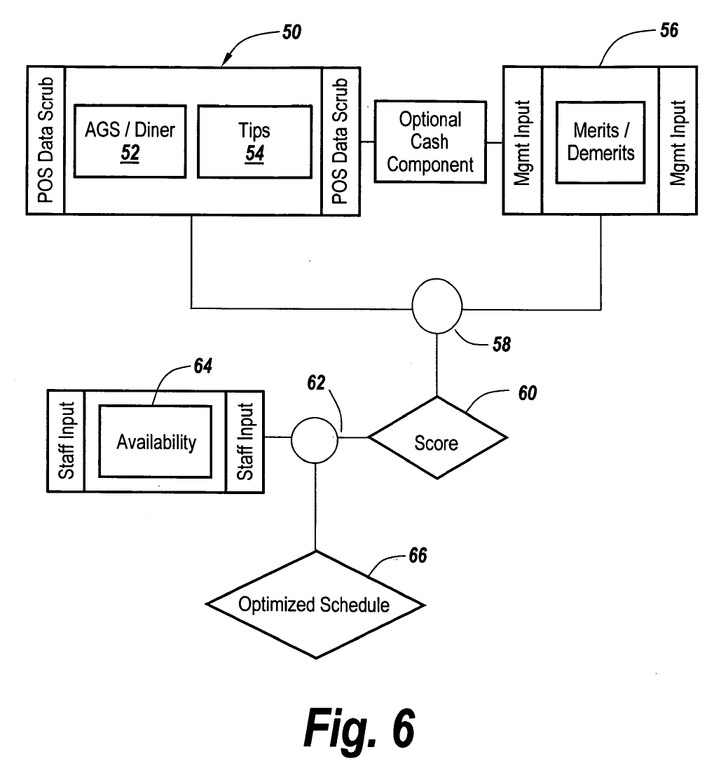

Referring to FIG. 6, the restaurant optimization engine flow is shown. A point of sale terminal has its data scrubbed as illustrated at 50, with the data to include the adjusted gross sales per diner 52 and the tips 54 that a server obtains. Thus, sales and customer satisfaction is obtained as an output from the point of sale device. Merit and demerit points, which constitute the management defined function, are illustrated as being inputted at 56, which are then combined with the output from unit 50 at a module 58. The output of module 58 is a score 60 which refers to the server score for a predefined period.

A module 62 combines a “raw score” and the availability 64 of a server and generates an optimized schedule 66 as illustrated.

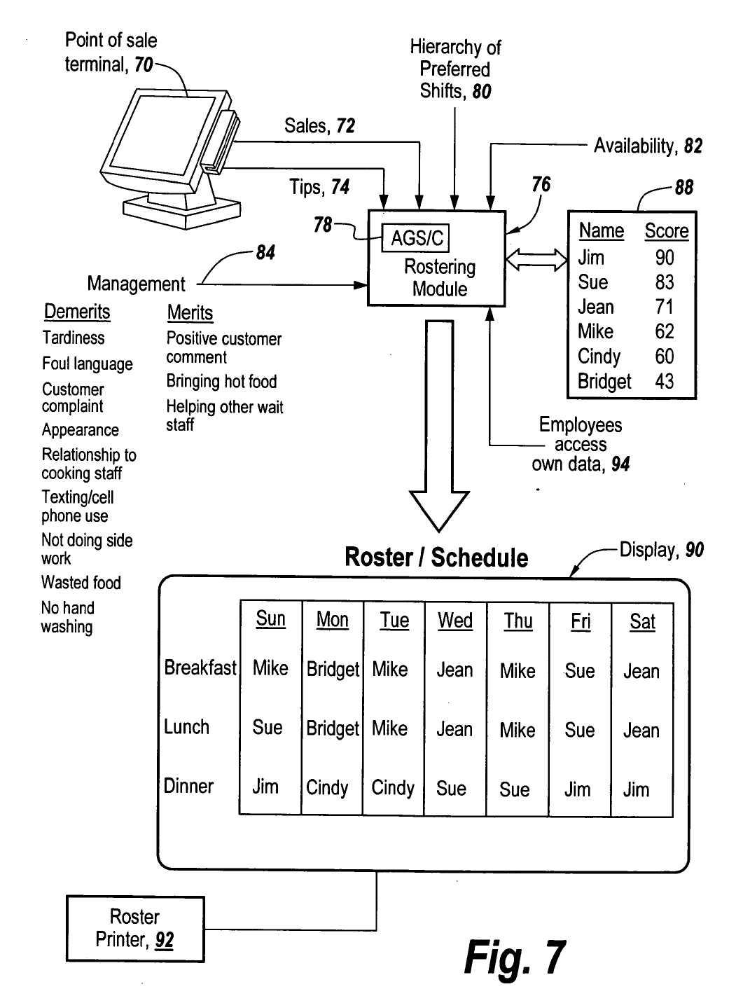

More particularly and referring now to FIG. 7, in terms of apparatus, a point of sale terminal 70 outputs sales 72 and tips 74 for a given server. Sales and tips are input to a rostering module 76, which calculates the adjusted gross sales per customer figure as illustrated at 78. It also calculates tip percentage. A hierarchy of preferred shifts is input by management at 80. Management can set up the hierarchy of shift desirability in terms of day of shift, section, shift type (double, single), shift time (day or night), and estimated duration, whereas server availability is inputted at 82. Availability can also be offset by employment labor law restrictions, e.g. maximum working hours per age group, and the time of day their shifts must end.

Finally, management parameters are input as illustrated at 84, which in one embodiment includes demerit and merit points. On the demerit side, tardiness, foul language, customer complaints, inappropriate appearance, bad relationship with cooking staff, text messaging or cell phone usage, not doing side work, wasted food and no hand washing result in demerits.

On the merit side positive customer comments, bringing hot food expeditiously and helping other service staff can result in merit points.

With all of inputs noted above, the rostering module generates a score card as illustrated at 88 which shows that Jim is the highest scorer at 90, whereas Bridget is the lowest scorer at 43, with Sue, Jean, Mike and Cindy ranked in between.

Rostering module 76 populates a display 90 in terms of a schedule, indicating breakfast, lunch and dinner shifts for a week, and indicates which servers will operate in selected shifts. The roster also places service staff in sections within a restaurant that are most desirable, e.g. Section 1 is busier than Section 4. Taking the Friday shift which is in general the more desirable and higher revenue shift, it can be seen that for breakfast and lunch Sue, who is ranked second at a score of 83, is provided with these shifts, whereas the super lucrative dinner shift is awarded to Jim with the highest score.

Monday, generally acknowledged to be the least desirable of the days, is given to Bridget for breakfast and lunch, and Cindy for dinner.

The individuals with the highest scores are provided with the most lucrative and desirable shifts taking into account their availability.

As mentioned hereinbefore, if a server having the highest score is not available for a given shift then the award is made to the next highest-ranking server.

The contents of the display is available at a roster printer 92 so that hard copies can be circulated amongst the staff, whereas employees may also access their own data remotely as illustrated at 94.

In some embodiments, the rostering module 76 may take into account the preferences of the servers. For example, each server may input or otherwise submit a “dream schedule” setting forth their desired shifts and/or sections, which may deviate from the hierarchical ranking of shift desirability described above. For example, Jim, the highest performer, may, for personal reasons, desire the Thursday dinner shift over the more generally lucrative Friday dinner shift.

Rostering module 76 then uses the input server preferences along with the server performance scores to generate an optimized schedule which provides the highest ranked servers with a schedule closely matching their submitted dream schedules. Once these schedules have been determined, section assignments may be made such that the highest ranked server scheduled for a given shift are assigned to the most desirable section.

In general, rostering module 76 may implement any suitable optimization technique including, for example, simulated annealing based algorithms (e.g., of the type available in the familiar GNU Scientific Computing Library distributed at http://www.gnu.org/software/gsl/). In other embodiments, any other suitable optimization techniques may be used including combinatorial, iterative techniques (finite difference methods, interpolation, pattern search methods, etc.), or heuristic techniques (genetic algorithms, differential evolution, dynamic relaxation, etc.), etc.

In various embodiments, rostering module 76 may perform the above described optimization subject to one or more constraints. For example, if a high performing serving requests a “dream schedule” which places him or her in mostly non-lucrative shifts, this high performer's talents may be underutilized. Accordingly the optimization may be constrained such that the highest performers must be scheduled in at least a threshold number of lucrative shifts (e.g., referring to the example above, the optimization may be constrained to ensure that at least two of the top three highest ranked performers are scheduled to work during the busy Friday dinner shift.). Any other suitable constraints (e.g., availability constraints, maximum hours per week constraints, etc.) may be used.

What will be seen is that while scheduling software exists, nowhere in this software is an optimization model that is based on server performance. By using the subject invention it is possible to ascertain from point of sale data the performance of a given server over a predetermined period of time and to schedule servers most likely to generate income and goodwill for the restaurant in the more desirable shifts. The scoring apparatus provides a healthy competition amongst the servers and therefore increases efficiency of restaurant operation, with servers being able to ascertain where they are lacking in performance, and thereby improve their performance and thus the bottom line of the restaurant.

In order to maintain healthy competition amongst the servers, it is important to provide scoring systems which fairly and accurately represent server performance. The system should be difficult for an unscrupulous server to “game” or “cheat” to his or her benefit at the detriment of more deserving performers. The following describes a non-limiting embodiment of such a system based on per person average (PPA) sales data.

As described above, a server's performance rank may be a composite, e.g., a weighted average of independent ranking components (i.e. methods for evaluating performance, e.g. sales, gratuity, cheating, tardiness, etc.). For clarity's sake, in the following example, a single component, normalized per person average (NPPA) sales will be used. However, in other embodiments, NPPA may be combined with any other suitable components to determine a composite rank.

PPA sales may be calculated for any given set of meal checks. The relevant set of checks is dependent upon on the context of PPA evaluation, e.g. a period of time and/or a specific individual, as described below. Let C be a set of checks such that cₙ is the nth element in the set. Let S be a function yielding the total sales for a given check, let P be a function yielding the number of seated individuals in that check. One may define the PPA for a given set of checks C as

$$PPA ( C ) = \frac{{\sum }_{n = 1}^{C} S ( {c}_{n} )}{{\sum }_{n = 1}^{C} P ( {c}_{n} )} , where P ( {c}_{n} ) \neq 0.$$

That is, PPA is the total sales over all checks in the set C divided by the total number of seated individuals over the set C. When used as a metric for individual performance, PPA accounts for disparities in the size of parties served by a given server.

For example, if server Jim waited on two tables each with two diners who each ordered $100 worth of food (presumably due in part to Jim's good performance and upselling), Jim would receive a PPA of $100 on gross sales of $400. If Bridget waited on two tables each with four diners who each ordered only $50 worth of food (presumably due in part to Bridget's poor performance and failure to upsell), Bridget would receive a PPA of only $50, on gross sales of $400. Accordingly, PPA provides a more accurate metric for determining a server's performance per sales opportunity, and properly identifies Jim as the higher performer in the present example.

As illustrated in the example above, in order to accurately determine PPA, party size must be accurately ascertained. For example, if Bridget finds a way to inaccurately report her party size as two diners per check, her PPA would increase to unfairly match Jim's PPA.

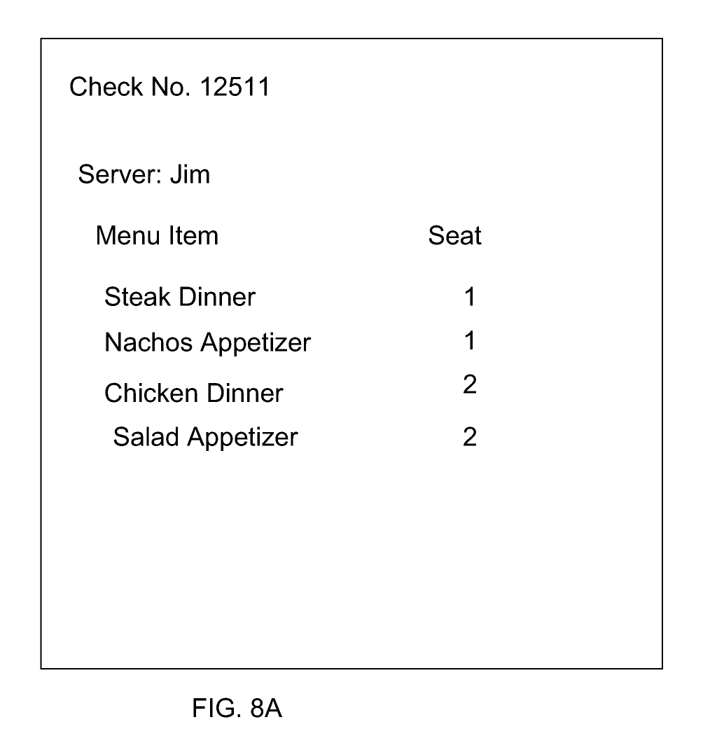

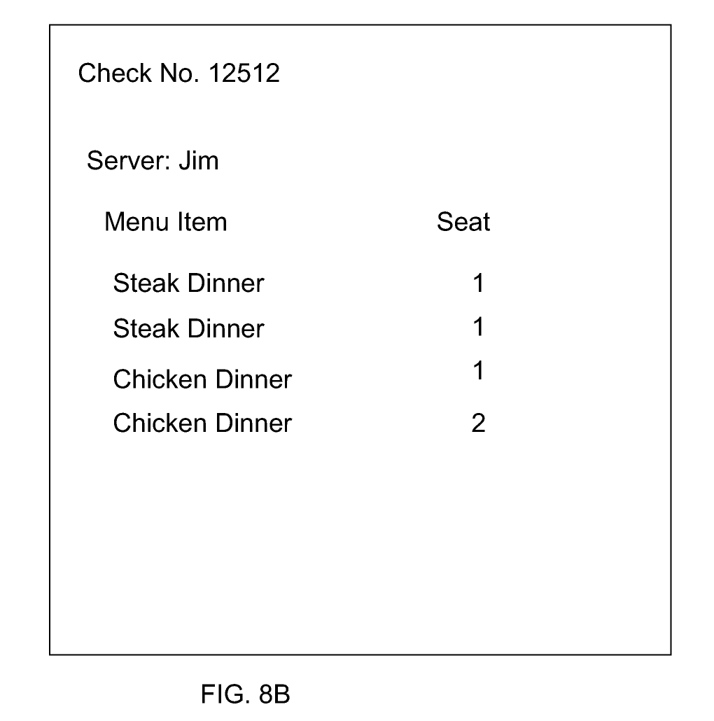

Accordingly, in some embodiments, the party size P for a given check is determined based on the seat assignments. For example, P may be calculated as the sum of the unique seat number assignments across all menu items on a check. All menu items must be assigned a seat number by the wait staff when entered into a point of sale system. Shared items may be dealt with by assigning these items to the seat number that ordered the item. FIG. 8A illustrates a check for a part of two, where each ordered menu item has been assigned to a seat number. For the check as illustrated, P=2. Using this technique, PPA serves a an accurate measure of sales opportunity as a function of the number of customers actively ordering food, excluding those who are not dining or ordering.

In typical settings, determination of party sized based on seat assignments allow for peer and/or management quality enforcement. Menu items are assigned seat numbers because multiple staff “run” (i.e. deliver) hot food as soon as it is available, regardless of whether or not they are responsible for that particular table. Food available at the expo station (i.e., kitchen window) is placed under a printed version of the check, which shows seat numbers. This allows two things to occur.

First, culinary professionals will view the checks and note inconsistencies with seat number and food assignments. For example, as illustrated in FIG. 8B when three entrees are assigned to a single seat number, it is likely that the server has dishonestly assigned the menu items to artificially lower the party size. The culinary professional may note this discrepancy and make an entry into the ranking system. This entry may be used for tracking purposes, or may serve as a demerit which may impact the server's rank.

Second, wait staff will view each other's checks, and immediately see inconsistencies, allowing them to raise concerns to management immediately if cheating is detected. Again, as detailed above, management may verify that cheating has occurred and enter demerits into the ranking system which negatively impact the server's rank.

To further enhance the fairness and accuracy of server rankings, the PPA of an individual server may be normalized to account for temporal (e.g., day of week, hour of day, season, etc.) variation, spatial variation (e.g., restaurant section), or other variations.

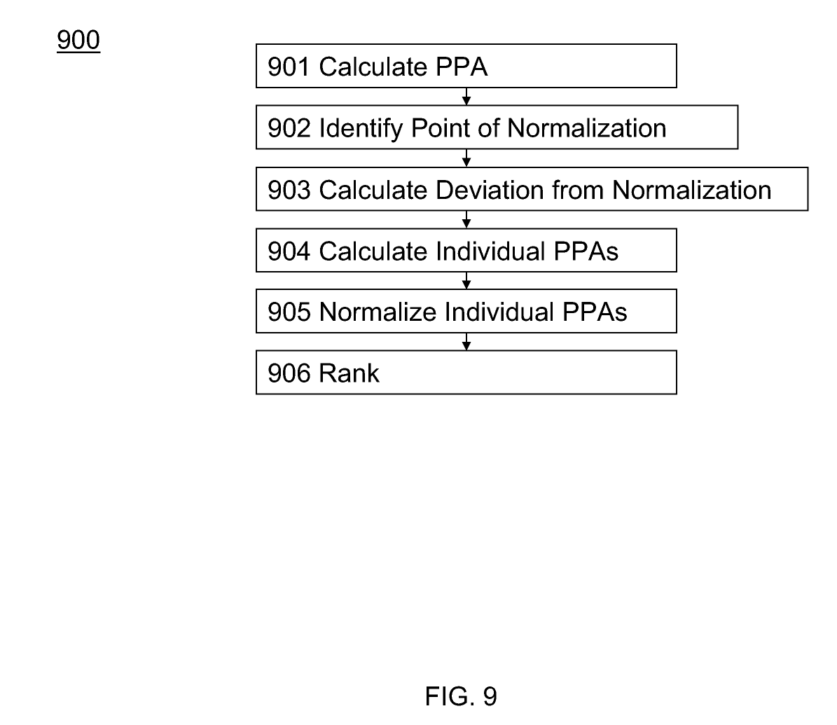

For example. FIG. 9 illustrates a process 900 for normalizing PPA to account for temporal variations in sales based on a rolling quarter year (13 weeks) historical sales data which includes hourly averages per day of week. Note that in other embodiments, any other suitable rolling window length, or no window at all (corresponding to the use of all available historical data) may be used.

Let U be a given set of checks. Let d be a day of week, where

dεD:{Mon,Tues, . . . ,Sun},

let t be a time of day where

tεT:{0, . . . ,23},

and let w be a week of quarter, where

wεW:{1,2, . . . ,13}.

Let H be a function of U mapping into itself for given dimensions, where

H_{d,t,w}:U→C∴⊂U

where C is the resulting check set. That is, the function H selects the subset of checks C corresponding to a given day, time and week.

In step 901, PPA is calculated for a given day of week and time of day, and averaged over a rolling 13-week period. This calculation may be performed by letting A be a function of H into itself, such that:

$${A}_{d , t} : \frac{{\sum }_{w = 1}^{13} S ( {H}_{d , t , w} )}{{\sum }_{w = 1}^{13} P ( {H}_{d , t , w} )} = \frac{{\sum }_{w = 1}^{13} PPA ( {H}_{d , t , w} )}{13} .$$

In step 902 a point of normalization is identified. For example, the point of normalization may be that maximum PPA such that

MAX_{A}:largestquantityA_{d,t} from all (d,t)εD×T.

In step 903 the PPA deviations from the point of normalization are determined for each day and time, such that

$$δ = \{ \sqrt{\frac{{\sum }_{w = 1}^{13} {( {MAX}_{A} - PPA ( {H}_{d , t , w} ) )}^{2}}{13}} \vert for each ( d , t ) ∈ D χ T \} .$$

In some embodiments, one may evaluate three hours worth of checks at a time, starting at t, ending at t+3 hours, for each H_{d,t,w}. This overlaps as we progress through the day in that there are always a ⅓ new checks of H for any given (d, t, w)εD×T×W (excluding the 1st hour, and the last 2 hours of the day). This smoothes anomalies. In other embodiments, a smoothing window of a different length may be used (e.g., 2 hours, 4 hours, 5 hours, etc

In step 904, individual PPA is captured for each server over a given time period (e.g., 2 weeks). For example, for each individual, let C be the last 2-weeks of checks for a specific employee. Let E be the set of day and time historical PPA for a given user. Then E may be calculated as:

$$E = \{ \sqrt{\frac{{\sum }_{w = 1}^{2} PPA ( {C}_{d , t , w} )}{2}} \vert for each ( d , t ) ∈ D χ T \} .$$

In other embodiments, other windows of historical data may be captured (e.g., 1 week, 3 weeks, 4 weeks, etc.). In the expression above, PPA is average over the number of weeks (corresponding to the value 2 in the denominator). However, in some embodiments, it is desirable to average over another value, e.g., the total number of checks or total number of shifts worked during the relevant time period. Such choices may account for irregularities in a server's work schedule.

In step 905, each individual's PPA is normalized to generate an NPPA that accounts for temporal sales variations. This is achieved by adjusting each quantity by its corresponding deviation and subsequently averaging. That is, for each individual NPPA may be calculated as:

$$R = \{ {E}_{d . t} + {δ}_{d , t} \vert for each ( d , t ) ∈ D χ T \} NPPA = \frac{{\sum }_{n}^{\vert R \vert} {R}_{n}}{\vert R \vert} .$$

In step 906, each individual is ranked by NPPA. As noted above, in some embodiments, the ranking may be a composite ranking taking into account both NPPA and other components (e.g., demerits, attendance, etc.).

Although one specific example of normalizing employee performance data to account for temporal variations has been set for, it is to be understood that any other suitable normalization may be used. For example, the NPPA concept described above could readily be extended to take into account spatial variations (e.g., in the case of a restaurant having sections with significantly different average sales in each of multiple sections, such as a lunch counter section and a formal dining section.)

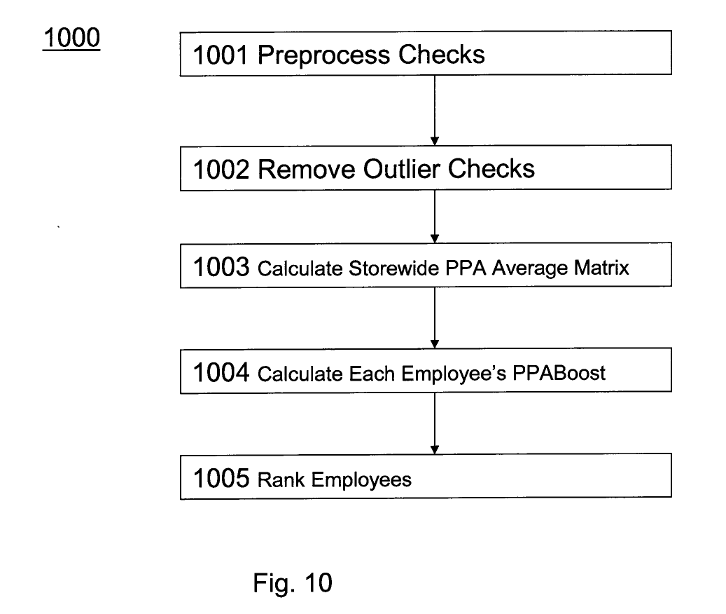

In some applications, alternative approaches to ranking based on PPA may be used. For example, FIG. 10 shows an exemplary alternative ranking process 1000. In this example, PPA is calculated using an exponentially weighted moving average technique.

Similar to the example shown above, the ranking is based on each server's PPA, the average sales per customer, used as an objective metric of the waitstaff's performance. For a given set of checks C,

$$PPA = \frac{{\sum }_{C}^{ } Total}{{\sum }_{C}^{ } EPS}$$

where Total is the total sales for a given check and EPS is the effective party size for the check. The effective party size may be determined as the larger of a) the party size for the check as input by the server and b) the seats served as determined number of seats linked to a check, calculated from seat assignments. As described above, each menu item in the check is linked to a seat, and the total number of distinct seats is defined as seats served. As described in the forgoing examples, basing the effective party size on the larger of these two quantities reduces the ability of a server to “game” the ranking system by reporting an artificially low party size for a check.

In some embodiments, an employee's PPA may be based on the complete historical record of checks for that employee. However, in many cases, it may be more accurate to calculate the employee's PPA using only checks from a given temporal window (e.g., checks from the last year, the last month, or some other time period). In some embodiments, PPA may be calculated as a weighted moving average, e.g., where more recent checks are given greater weight than checks from the more distant past. For example, the weighting of checks from a given time period may decrease (e.g. exponentially) as a function of time. In various embodiments, the weighting may be selected in order to provide a large enough window to smooth out volatility (e.g., random day to day variations), while basing the calculated average most strongly on more recent, up to date information that accurately captures the current state of the employees performance.

As in the examples above, the PPA is normalized to account for variations in PPA that do not reflect the server's performance (e.g., variations based on the day of the week and/or the time of the day). In some embodiments, a storewide average PPA matrix is PPAavg is calculated. Each element in the matrix corresponds to a storewide average PPA for checks grouped for a given day of the week and time of the day. For example, if the store is open seven days a week, for eight hours (e.g., 10 AM to 6 PM), PPAavg may be an 7×8 matrix having rows corresponding to hours in the day and columns corresponding to days in the week. For example element at row 2, column 3 could correspond to the storewide average for checks entered on Tuesday between 11 AM and 12 PM. As will be understood by one skilled in the art, any other suitable temporal grouping of checks may be used. In some embodiments, other types of groupings may be used including spatial groups (e.g., grouping checks by the location where the party was seated).

In some embodiments, the storewide average PPA may be based on the complete historical record of checks. However, in many cases, it may be more accurate to calculate the storewide average PPA using only checks from a given temporal window (e.g., checks from the last year, the last month, or some other time period).

In some embodiments, the storewide average PPA may be calculated as a weighted moving average, e.g., where more recent checks are give greater weight than checks from the more distant past. For example, the weighting of checks from a given time period may decrease (e.g. exponentially) as a function of time. In various embodiments, the weighting may be selected in order to provide a large enough window to smooth out volatility, while basing the calculated average most strongly on more recent, up to date information that accurately captures the current state of the store's operation.

The figure of merit used for the ranking is PPAboost the extra PPA gained by waitstaff comparing to the store-wide average. Given a set of checks C. one finds the corresponding element from the PPAavg matrix for each check, and then

$$PPA boost = \frac{{\sum }_{C}^{ } ( Total - EPS \times PPAvg )}{{\sum }_{C}^{ } EPS} .$$

In some embodiments, PPAboost may be the sole figure of merit for ranking the waitstaff (e.g., with the server with highest PPAboost being given the highest rank). In some embodiments, PPAboost may be combined with other factors (e.g., demerits, or any other factors described herein) to form a composite score for the ranking.

Referring to FIG. 10, the exemplary process 1000 is used to rank the waitstaff at a store. In the example shown the store operates 24 hours per day, 7 days per week. The process is carried out daily to provide a daily ranking of the waitstaff.

In step 1001, a preprocessing step is performed to remove any checks that are not appropriate for inclusion in the calculation. For example, in step 1001, any cancelled or refunded checks may be removed. In various embodiments other criteria may be used. For example, in some cases management may be able to flag checks for removal based on special circumstances.

In step 1002, optionally, the store's checks may be analyzed to identify and remove outlier checks. For example, for each check remaining after step 1001, PPA for the check is calculated. The checks are then ranked by PPA and outlier checks removed. In some embodiments, the highest a percent of checks may be removed. In some embodiments, the lowest b percent of checks are removed. The values for a and b may be the same, or different. The values for a and b may be any suitable amount, e.g., 5%, 2.5%, 1% or 0.5%. In some embodiments, outliers may, additionally or alternatively, be removed based on a comparison with a suitably chosen threshold PPA values. For example, all checks with a PPA of $1, or any other suitable value, or less may be removed.

In some embodiments, the outlier removal step 1002 may be performed using checks taken over several days. However, in many applications, the distribution of check values is fairly stable on a day to day basis. Accordingly, in some embodiments, after the process 1000 is run for the first time, the step 1002 may be performed using only checks from the current day. This can improve the speed and efficiency of the process, by avoiding the need to query more than one day's checks.

In step 1003, the storewide average PPA matrix is calculated. The calculation is based on function get_MAVG(checks) that operates on a set of checks to return a matrix where the element get_MAVG(i,j) at the ith row and jth column of the matrix corresponds to the average PPA for checks from the ith day of the week and jth hour of the day.

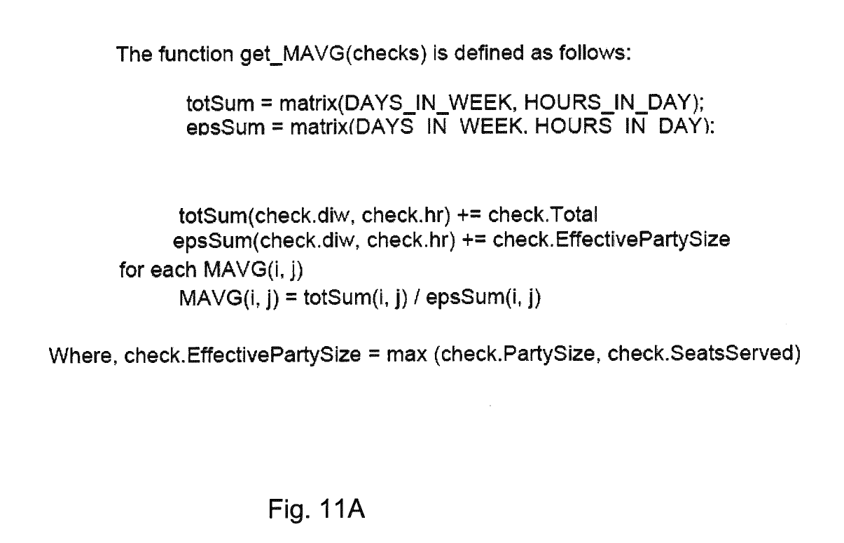

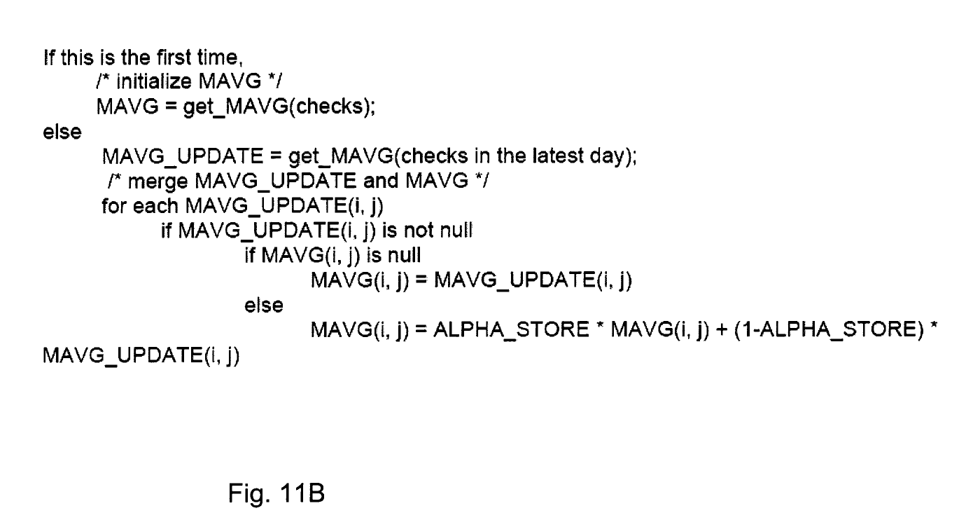

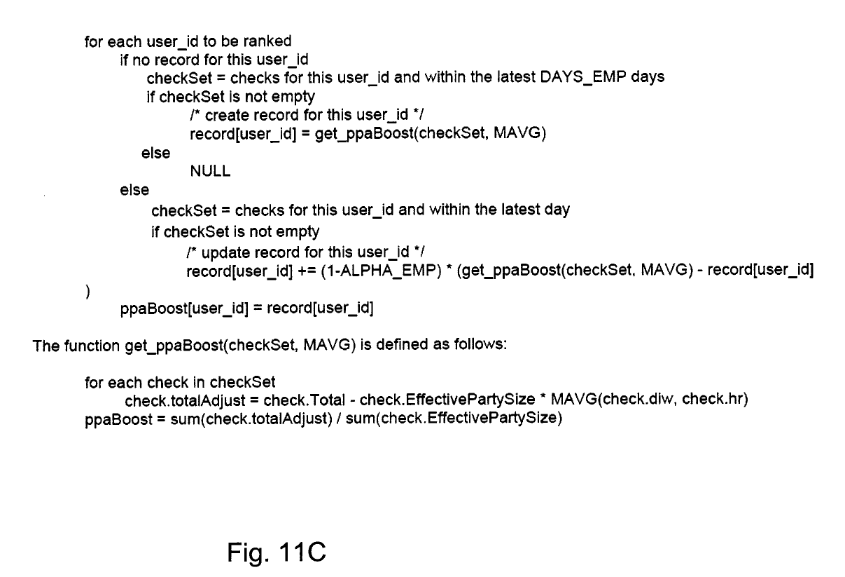

Exemplary program code for the function get_MAVG(checks) is shown in FIG. 11A. However, it is to be understood that other suitable implementations may be used.

The first time the process 1000 is run, in step 1003, the storewide average PPA matrix is calculated by having the function get_MAVG operate on all of the checks remaining after steps 1001 and 1002. This matrix is then stored as MAVG.

For each subsequent day that process 1000 is run, in step 1003, the function get_MAVG operates on only those checks for the current day that survive steps 1001 and 1002. The result is stored as MAVG_UPDATE. The average PPA is then calculated by merging MAVG_UPDATE with the previous day's MAVG as follows. For each element of the matrix MAVG_UPDATE(i,j), if the element is not null, and the corresponding element of MAVG(i,j) from the previous day is null, then the corresponding element for MAVG(i,j) for the current day is set to the MAVG_UPDATE(i,j). Otherwise, MAVG(i,j) for the current day is set to:

MAVG(i,j)^{today}=α_{STORE}MAVG(i,j)^{yesterday}+(1−α_{STORE})MAVG_UPDATE(i,j)

where α_{STORE} is a scalar value less than 1 (e.g. 0.95). The effect of this operation is to calculate a weighted moving average where the contribution from checks in the more distant past decays with time. After N iterations of the process 1000, checks that are N days old will be weighted by a factor proportional to α_{STORE}^{N}. Accordingly, the store average PPA matrix is an exponentially decaying moving average in time. The rate of decay increases with increasing α_{STORE}. As noted above, in some embodiments, α_{STORE} is chosen to balance the concerns of providing a large enough temporal window to smooth out volatility, while basing the calculated average most strongly on more recent, up to date information that accurately captures the current state of the store's operation.

FIG. 11B shows an exemplary program code for implementing step 1003. However, it is to be understood that other suitable implementations may be used.

In step 1004, the normalized PPA for the waitstaff is calculated. Each member of the waitstaff is assigned a user identification number user_id. For each user_id to be ranked, the following substeps are carried out. If no previous record is available for the user_id, the process searches for any checks for that user_id from within the last given number of days DAYS_EMP (e.g., 14 days). If no checks are found, this user_id's record is set to null.

If some checks are found, the user_id's checkSet is set equal to the checks for that user_id within the last DAYS_EMP days. The PPABoost for the user_id is then calculated as a function of both the associated checkSet, and the storewide average PPA matrix MAVG generated in step 1003.

In some embodiments, the PPABoost calculation can be implemented using a function get_ppaBoost(checkSet, MAVG) that operates as follows. For each check in the checkSet, the check's effective party size check.EffectivePartySize, check total check.total, check day in week check.diw, and check hour in day check.hr are determined. An adjusted check total check.totalAdjust is calculated as:

check.totalAdjust=check.Total−check.EffectivePartySize*MAVG(check.diw,check.hr)

Where MAVG(check.diw, check.hr) is the element of MAVG corresponding to the check's day in week and hour in day.

The PPABoost associated with the user_id is then calculated by dividing the sum over the check set of the adjusted check totals divided by the sum over the check set of the check effective party sizes:

PPABoost=sum(check.totalAdjust)/sum(check.EffectivePartySize).

The user_id's record is then set to the calculated PPABoost.

record[user_id]=PPABoost[user_id].

When the user_id has an associated record from a previous iteration of the process 1000, the record is updated as follows. The checkSet associated with the user_id is set equal to the checks for that user_id for the latest day. The PPABoost for that day is then calculated as above, but as a function of the day's checkSet, and the storewide average PPA matrix MAVG generated in step 1003. This value is then combined with the previous PPABoost value recorded for the user_id using

record[user_id]^{UPDATED}=(1−α_{EMP})PPABoost^{TODAY}−record[user_]^{PREVIOUS}

where α_{EMP} is a scalar value than 1 (e.g. 0.70). The effect of this operation is to calculate a weighted moving average of the wait staff member's PPABoost where weight for the contribution from checks in the more distant past decays with time. After N iterations of the process 1000, checks that are N days old will be weighted by a factor proportional to α_{EMP}^{N}. Accordingly, PPABoost record associated with each user_id is a exponentially decaying moving average in time. The rate of decay increases with increasing α_{EMP}. As noted above, in some embodiments, α_{STORE} is chosen to balance the concerns of providing a large enough temporal window to smooth out volatility, while basing the calculated average most strongly on more recent, up to date information that accurately captures the current state of the employee's performance.

FIG. 11C shows an exemplary program code for implementing step 1004. However, it is to be understood that other suitable implementations may be used.

In step 1005, the waitstaff is ranked. Once the record for each user_id has been updated in step 1004, the user_id's are sorted by record, and the sorted list is output as the ranking. In some embodiments, the record of the waitstaff's PPAboost may be combined with other factors (e.g., demerits, or any other factors described herein) to form a composite score for the ranking.

While several embodiments of the subject invention have been described in terms of its use in the restaurant industry, it will be appreciated that merit-based scheduling can be applied to a number of different industries.

As such, the subject invention includes any system in which performance is based on gratuities or tips and relates to any system which records the gratuities or tips and uses them in part as a factor in scheduling or rostering. The subject system includes for instance, tip based scheduling of taxi drivers, luggage handlers, hairdressers, limousine drivers, estheticians, massage therapists, or any scheduled services involving tips or gratuities.

In some embodiments, performance may be based on any other suitable metric or metrics, including, for example, sales based metrics (total sales, average sales, normalized sales, upselling etc.), ratings (customer ratings, peer ratings, supervisor ratings, etc.), attendance, etc. Data used to generate the performance metric may be acquired from any suitable sources including a point of sale system, personal digital devices (e.g., cell phones such as smart phones), etc. The data may include information related to the amount, time, location, or other aspect of a sale. Location information may be obtained using location tracking enabled devices (e.g., “GPS” global positioning system enabled devices) carried by the employee.

For example, a ranking and rostering system of the type described herein may be used in the context of an auto dealership. Each salesperson carries a GPS enabled mobile device which allows for the tracking of sales be salesperson, time, and location. Data generated through this tracking may be analyzed to identify “hot spot” locations and/or times where and when the most lucrative and/or frequent sales are made. Salesperson performance may be tracked using any suitable metric to provide a performance ranking. High performing salespersons may be assigned to the most desirable shift times and/or locations. As with restaurants, historical sales data can be used to normalize the performance metrics to account for spatial and/or temporal variations in average sales, in order to improve the fairness and accuracy of the performance ranking.

As will be apparent to one skilled in the art, ranking and rostering systems of the type described herein may be applied to essentially any situation where it is desirable to assign sales opportunities based on a performance ranking. Although several examples have been presented above where the assignment of sales opportunities involves a temporal and/or spatial scheduling, other types of assignments may be made.

For example, a telemarketing company may have a pool of sales leads (i.e. contact information for individuals or businesses who may be interested in purchasing a product.) This pool of sales leads may be divided in to sub-pools of the most promising leads, moderately promising leads, and least promising leads. Using the techniques described herein, the sales force of the company may be ranked based on various performance metrics, and the most promising leads assigned to the highest ranked individuals.

The devices, systems, processes, and techniques described herein may be implemented with and or integrated into any suitable know system capable of recording employee performance. For example, U.S. Pat. No. 7,385,479, the entire contents of which are incorporated herein by reference, describes a data processing system for analyzing customer and employee interactions in a service establishment is disclosed. The data processing system includes a plurality of remote customer units, employee units and a central unit. The units each include a transceiver to send and receive signals. The signals are all received by the central unit and relayed to the appropriate unit. The central unit time stamps and records all signals in a database. The system further comprises an evaluation program which analyzes the signal data to provide employee performance ratings and staffing recommendations.

The employee ranking and rostering technology described in the present disclosure may be integrated into this system to provide improved ranking accuracy and objectivity.

Similarly, the devices, systems, processes, and techniques described herein may be used to improve the employee performance monitoring systems described in U.S. Pat. Pub. Nos. 20060259471 and 20070282650, the entire contents of which are incorporated herein by reference.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a viewer, the above described techniques can be implemented on a computer having a display device. The display device can, for example, be a cathode ray tube (CRT) and/or a liquid crystal display (LCD) monitor. The interaction with a viewer can, for example, be a display of information to the viewer and a keyboard and a pointing device (e.g., a mouse or a trackball) by which the viewer can provide input to the computer (e.g., interact with a viewer interface element). Other kinds of devices can be used to provide for interaction with a viewer. Other devices can, for example, be feedback provided to the viewer in any form of sensory feedback (e.g., visual feedback, auditory feedback, or tactile feedback). Input from the viewer can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical viewer interface, a Web browser through which a viewer can interact with an example implementation, and/or other graphical viewer interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other type of communication device. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. A method comprising:
using at least one point of sale terminal to record sales information related to each of a plurality of staff members of an enterprise;
using a rostering module coupled to the point of sale terminal to generate information indicative of staff performance by generating a performance score for each staff member that is based on sales information for the staff member and on aggregate sales information for the enterprise; and
using the rostering module to generate a roster for scheduling staff members in scheduling slots based on each staff member's performance score.

2. The method of claim 1, comprising, for each of the plurality of staff members, generating a corresponding performance score by:
grouping the staff member's sales information into a plurality of categories;
obtaining aggregate sales information for the enterprise corresponding to each of the categories; and
normalizing the staff member's sales information for each category based on the corresponding aggregate sales information.

3. The method of claim 2, wherein the categories comprise temporal categories.

4. The method of claim 3, wherein the temporal categories are based on a day of week and a time of day.

5. The method of claim 2, wherein the categories comprise spatial categories.

6. The method of claim 2, wherein the step of generating a performance score for each staff member that is based on sales information for the staff member and on aggregate sales information for the enterprise comprises:
calculating a performance score based on staff member sales information and aggregate sales information generated over a period of time,
wherein the performance score more heavily weights staff member sales information and aggregate sales information that is more recent in the period of time.

7. The method of claim 6, wherein at least one of the staff member sales information and aggregate sales information is weighted by a factor that decreases exponentially as a function of how distant in the past the information was generated.

8. The method of claim 6, wherein:
the enterprise comprises a restaurant; and
each staff member's sales information comprises a plurality of check records, each check record comprising:
party size information indicative of the number of persons in a party served by the staff member; and
total sales information indicative of the total sales for the party;
the method further comprising, for each staff member:
generating per person average sales information indicative of the sales per person served by the staff member based on the plurality of check records.

9. The method of claim 8, wherein each check record comprises:
a party size entered by the staff member; and
seating information indicative of the number of seats at a dining table served;
wherein generating per person average sales information indicative of the sales per person served by the staff member based on the plurality of check records comprises:
dividing the total sales for a party by the larger of the party size entered by the staff member and the number of seats.

10. The method of claim 9, further comprising:
providing one or more interfaces configured to allow a first staff member to confirm or dispute the party size or seating information in a check record of a second staff member.

11. The method of claim 8, further comprising:
identifying check records as outliers based on per person average sales information; and
removing the outliers from consideration in generating the staff member performance scores.

12. The method of claim 8, wherein the aggregate sales information for the enterprise comprises information indicative of an average of the per person average sales for the plurality of staff members.

13. The method of claim 12, further comprising:
categorizing the aggregate sales information based on the time of day and day of week of the sales.

14. The method of claim 13, further comprising:
categorizing the aggregate sales information based on the spatial locations of the sales within the restaurant.

15. An apparatus comprising:
at least one point of sale terminal configured to record sales information related to each of a plurality of staff members of an enterprise; and
a rostering module coupled to said point of sale terminal and configured to generate information indicative of staff performance by generating a performance score for each staff member that is based on sales information for the staff member and on aggregate sales information for the enterprise;
wherein the rostering module is configured to generate a roster for scheduling staff members in scheduling slots based on each staff member's performance score.

16. The apparatus of claim 15, wherein the rostering module is configured to, for each of the plurality of staff members, generating the performance score by:
grouping the staff member's sales information into a plurality of categories;
obtaining aggregate sales information for the enterprise corresponding to each of the categories; and
normalizing the staff member's sales information for each category based on the corresponding aggregate sales information.

17. The apparatus of claim 16, wherein the categories comprise temporal categories.

18. The apparatus of claim 17, wherein the temporal categories are based on a day of week and a time of day.

19. The apparatus of claim 16, wherein the categories comprise spatial categories.

20. The apparatus of claim 16, wherein the rostering module is configured to generate a performance score for each staff member that is based on sales information for the staff member and on aggregate sales information for the enterprise by:
calculating a performance score based on staff member sales information and aggregate sales information generate over a period of time,
wherein the performance score more heavily weights staff member sales information and aggregate sales information that is more recent in the period of time.

21. The apparatus of claim 20, wherein at least one of the staff member sales information and aggregate sales information is weighted by a factor that decreases exponentially as a function of how distant in the past the information was generated.

22. The apparatus of claim 20, wherein:
the enterprise comprises a restaurant; and
each staff member's sales information comprises a plurality of check records, each check record comprising:
party size information indicative of the number of persons in a party served by the staff member; and
total sales information indicative of the total sales for the party;
the rostering module is further configured to, for each staff member:
generate per person average sales information indicative of the sales per person served by the staff member based on the plurality of check records.

23. The apparatus of claim 22, wherein:
each check record comprises:
a party size entered by the staff member; and
seating information indicative of the number of seats at a dining table served;
the rostering module is configured to generate per person average sales information indicative of the sales per person served by the staff member based on the plurality of check records by:
dividing the total sales for a party by the larger of the party size entered by the staff member and the number of seats.

24. The apparatus of claim 23, further comprising:
one or more interfaces configured to allow a first staff member to confirm or dispute the party size or seating information in a check record of a second staff member.

25. The apparatus of claim 24, wherein the rostering module is configured to:
identify check records as outliers based on per person average sales information; and
remove the outliers from consideration in generating the staff member performance scores.

26. The apparatus of claim 22, wherein the aggregate sales information for the enterprise comprises information indicative of an average of the per person average sales for the plurality of staff members.

27. The apparatus of claim 26, wherein the rostering module is configured to:
categorize the aggregate sales information based on the time of day and day of week of the sales.

28. The apparatus of claim 27, wherein the rostering module is configured to:
categorize the aggregate sales information based on the spatial locations of the sales within the restaurant.

29. A system comprising:
an apparatus comprising:
at least one point of sale terminal configured to record sales information related to each of a plurality of staff members of an enterprise; and
a rostering module coupled to said point of sale terminal and configured to generate information indicative of staff performance by generating a performance score for each staff member that is based on sales information for the staff member and on aggregate sales information for the enterprise;
wherein the rostering module is configured to generate a roster for scheduling staff members in scheduling slots based on each staff member's performance score; and
a database coupled to the apparatus and configured to store the sales information related to each of a plurality of staff members of an enterprise.

30. The system of claim 29, further comprising:
an output device for outputting information generated by the rostering module.
